(19) United States
(12) Patent Application Publication
(10) Pub. No.: US 2014/0261228 A1
(43) Pub. Date: Sep. 18, 2014

(54) Apparatus for cleaning ad drying animal's paws

(71) Applicant: James Welfer Moore, Jr., Pasadena, MD (US)

(72) Inventor: James Welfer Moore, Jr., Pasadena, MD (US)

(21) Appl. No.: 14/200,250

(22) Filed: Mar. 7, 2014

Related U.S. Application Data
(60) Provisional application No. 61/851,625, filed on Mar. 12, 2013.

(51) Int. Cl. A01K 13/00

(52) U.S. Cl. CPC A01K 13/001
USPC 119/652

(57) ABSTRACT

An apparatus for cleaning and drying an animal's paws comprises a bag formed from an absorbent material. The bag has a stiffening band incorporated into its open end so that the bag can easily receive an animal's paw. A sleeve extends around the periphery of an open end of the bag to protect a user's hand.

### CROSS-REFERENCE TO RELATED APPLICATIONS

This application claims the benefit of U.S. Provisional Application 61/851,625 filed Mar. 12, 2013.

### BACKGROUND OF THE INVENTION

The invention relates to cleaning and drying devices for animal paws and legs. Animals' paws often become wet and dirty through contact with the outdoors. Before reentering the house or car after contact with the ground it is often preferable to clean the paws and legs of the animal.

It is known that water based cleaning devices are available to wash the animals paws. These devices are generally cumbersome to use and store. After the cleaning there is waste water that must then be disposed of Additionally, these devices leave wet residue on the paw.

Alternatively, people use paper towels or wipes to clean the paws. This method is not convenient and generally not very effective. When a user wipes a paw, a portion of the dirt ends up on the ground. Additionally, there is significant waste with these discarded towel/wipes.

Accordingly, there is need for an improved cleaning/drying device that does not use water, prevents the wiped dirt from falling to the ground, is very portable and is reusable.

### SUMMARY OF THE INVENTION

The invention solves the above-described problems and provides distinct advantages in the art of cleaning and drying of animals paws. This apparatus provides for individually cleaning and drying each of the paws, is easily moved and stored, does not use water and can be easily cleaned for reuse.

The apparatus comprises an absorbent bag with a permanently installed stiffening band along the open-end to maintain the bag in an open position. It also comprises a sleeve/strap to hold one's hand to the bag.

### BRIEF DESCRIPTION OF THE DRAWINGS

FIG. 1 is a perspective and side view of a paw cleaning apparatus;

FIG. 2 is a perspective and front view of a paw cleaning apparatus;

FIG. 3 is a perspective and back view of a paw cleaning apparatus;

FIG. 4 is a perspective and side view showing how the hand is held between the sleeve/strap and the bag;

FIG. 5 is a perspective and back view showing how the hand is held between the sleeve/strap and the bag;

FIG. 6 is a perspective and side view showing the animal's paw inserted into the bag;

FIG. 7 is a perspective and side view of the animal's paw inserted into the bag while separated from the hand being held between the bag and the sleeve/strap.

### DETAILED DESCRIPTION OF THE INVENTION

The invention is made primarily of an absorbent material with a closed end 5 and an open end 1 with a stiffening band 2 sewn into the outer opening. It has a Sleeve/Strap 3 attached to the outside of the bag 4.

The dimensions of the cleaning/drying apparatus may vary according to the size of different paws. The material used can be any fabric that is both flexible and absorbent. Additionally, identifying markings such as graphic designs and logos can be placed on the apparatus for identification.

The open end of the cleaning/drying apparatus 1 is held open by a stiffening device 2. This stiffening device 2 can be made out of metal, plastic and or any material strong enough to hold the bag 4 in an open position. The stiffening device 2 is either attached to the outside of the bag 4 or hemmed into the material of the bag 4. The stiffening device 2 is designed to fit the contour of the outside of the bag 4 to assist in guiding the animal's paw into the bag 4. The stiffening device 2 can be a closed loop (such as a circle or oval) or open ended as shown in the FIG. 1. By rigidly opening the bag 4 the animal's paw can slide into the bag without catching or snagging on the interior of the bag.

The bag section 4 of the cleaning/drying apparatus is constructed of flexible absorbent material. The absorbent material can be made of but is not limited to materials such as microfiber or terrycloth. After the paw is guided into the open end 1 of the cleaning/drying apparatus it is easy to manipulate the paw from the outside of the flexible bag 4. This allows you to clean and dry the paw without direct contact. The absorbent material assists in the drying of the wet paw. The closed end of the bag 5 traps any large debris that is whisked off of the paw during the cleaning/drying process.

The sleeve/strap 3 of the invention is affixed to the outside of the bag and extends around the entire top periphery of the bag. It is designed to hold the users hand (either left or right) to the bag and protect the hand from the paw. Additionally, the sleeve/strap 3 can be used for storing/hanging the apparatus. The users hand slides between the bag 4 and the sleeve/strap 3 (shown as a sleeve in these drawings), thus there is no need to grab and therefore narrow the opening of the bag 4. The apparatus will hang from the user's wrist maintaining the bag 4 in a fully open position ready to receive the animals paw. After the paw is guided into the bag the hand can squeeze and manipulate the paw without fear of dropping the apparatus.

In operation, the user inserts his/her hand between the sleeve 3 and the bag 4. With the bag 4 loosely held to the user's hand the animals paw is guided through the opening of the bag 1. The user then manipulates the flexible absorbent material of the bag around and between the pads/toes of the animals paw. The larger debris is caught in the bottom of the bag. The lighter debris and water is deposited in/on the absorbent material of the bag. After the animal's paws are sufficiently cleaned/dried the apparatus can be hung by the sleeve conveniently for the next use. The apparatus is reusable. After the user determines that the apparatus is too dirty for additional uses it can be turned inside out and washed for reuse. As soon as the apparatus is dry it is ready to use again.

1. An apparatus for cleaning and drying an animal's paws comprising:
a bag having a closed end and an open end;
a stiffening band extending around the open end;
a sleeve attached to and extending around the periphery of the open end.

2. The apparatus of claim 1 wherein the bag is made from an absorbent material.

3. The apparatus of claim 2 wherein the absorbent material is terrycloth.

4. The apparatus of claim 2 wherein the absorbent material is microfiber cloth.

5. The apparatus of claim 1 wherein the stiffening band is made of plastic.

6. The apparatus of claim 1 wherein the stiffening band is made of metal.

7. The apparatus of claim 1 wherein the stiffening band is made of a any material capable of holding the bag open.

8. The apparatus of claim 1 wherein the sleeve at the open end of the device is made from any material capable of holding the hand to the bag.
